(19) United States
(12) Patent Application Publication
(10) Pub. No.: US 2025/0124807 A1
(43) Pub. Date: Apr. 17, 2025

(54) SYSTEMS AND METHODS FOR DRIVER TRAINING USING ZONE OF PROXIMAL LEARNING

(71) Applicant: Toyota Research Institute, Inc., Los Altos, CA (US)

(72) Inventors: Guy Rosman, Newton, MA (US); Jonathan A. DeCastro, Arlington, MA (US); Deepak Edakkattil Gopinath, Chicago, IL (US); Xiongyi Cui, Somerville, MA (US); Emily Sumner, Mountain View, CA (US)

(73) Assignees: Toyota Research Institute, Inc., Los Altos, CA (US); Toyota Jidosha Kabushiki Kaisha, Aichi-ken (JP)

(21) Appl. No.: 18/898,014

(22) Filed: Sep. 26, 2024

Related U.S. Application Data
(60) Provisional application No. 63/589,506, filed on Oct. 11, 2023.

(51) Int. Cl. G09B 9/042; B60W 40/09; B60W 50/14; B60W 60/00

(52) U.S. Cl. CPC G09B 9/042; B60W 40/09; B60W 50/14; B60W 60/001; B60W 2420/403

(57) ABSTRACT

In one embodiment, a computer-implemented method for driver training using zone of proximal learning (ZPL) includes receiving, by one or more processors, driving data with respect to a driver operating a vehicle, estimating, using a personal behavior model, a driver profile based on the driving data, estimating one or more zone of proximal development (ZPD) states based at least in part on the driver profile, and performing one or more vehicle actions to place the driver into the one or more ZPD states.

### CROSS-REFERENCE TO RELATED APPLICATIONS

This application claims priority to Provisional Patent Application No. 63/589,506 filed on Oct. 11, 2023 and entitled “Systems and Methods for Driver Training Using Zone of Proximal Learning Estimation,” the entirety of which is incorporated by reference herein.

### TECHNICAL FIELD

The present disclosure relates to driver training, and more particularly, to intelligent personalized driver training.

### BACKGROUND

Driving is a multifaceted skill that involves coordination among various body parts and real-time decision-making. The role of driver training may be important in imparting the desirable knowledge and skills to ensure safe driving in complex and dynamic environments. As a result, the need for methods and systems for comfortable and challenging driving training remains unfulfilled.

### BRIEF SUMMARY

In one embodiment, a computer-implemented method for driver training using zone of proximal learning (ZPL) includes receiving, by one or more processors, driving data with respect to a driver operating a vehicle, estimating, using a personal behavior model, a driver profile based on the driving data, estimating one or more zone of proximal development (ZPD) states based at least in part on the driver profile, and performing one or more vehicle actions to place the driver into the one or more ZPD states.

In another embodiment, a system for driver training using zone of proximal learning (ZPL), includes one or more processors and a non-transitory, computer-readable medium storing instructions that, when executed by the one or more processors, cause the one or more processors to receive driving data with respect to a driver operating a vehicle, estimate, using a personal behavior model, a driver profile based on the driving data, estimate one or more zone of proximal development (ZPD) states based at least in part on the driver profile, and generate commands to perform one or more vehicle actions to place the driver into the one or more ZPD states.

In another embodiment, a vehicle includes one or more sensors operable to generate driving data with respect to a driver operating the vehicle. The vehicle also includes one or more processors and a non-transitory, computer-readable medium storing instructions that, when executed by the one or more processors, cause the one or more processors to receive the driving data, estimate, using a personal behavior model, a driver profile based on the driving data, estimate one or more zone of proximal development (ZPD) states based at least in part on the driver profile, and generate commands to perform one or more vehicle actions to place the driver into the one or more ZPD states.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram of the zone of proximal learning according to one or more embodiments described and illustrated herein.

FIG. 2 illustrates a vehicle driving within an environment according to one or more embodiments described and illustrated herein.

FIG. 3 illustrates a diagram of an example zone of proximal learning system according to one or more embodiments described and illustrated herein.

FIG. 4 illustrates an example computing device of a zone of proximal learning system according to one or more embodiments described and illustrated herein.

### DETAILED DESCRIPTION

Embodiments of the present disclosure provide zone of proximal learning (ZPL) systems and methods for driver training using zone of proximal development (ZPD). ZPD refers to the difference between what a driver can do without help and what the driver can achieve with guidance and encouragement from a skilled partner, such as a computer-assisted learning program. It represents the tasks that are beyond the driver's current driving abilities but are attainable with the help and guidance of the system.

Vehicle driving is a complex skill that involves the coordination of various body parts and real-time decision-making. Training may equip individuals with the desirable knowledge and skills to navigate complex and dynamic driving environments. Due to the knowledge, experience, enthusiasm, expression ability, and cultural background limitations of human coaches, as well as the limitation of human communication means (verbal, body language, eye contact, etc.), the limitations of human coaching methods may result in unsatisfied training. The systems and methods disclosed herein can be a solution to improve human coaching driver training.

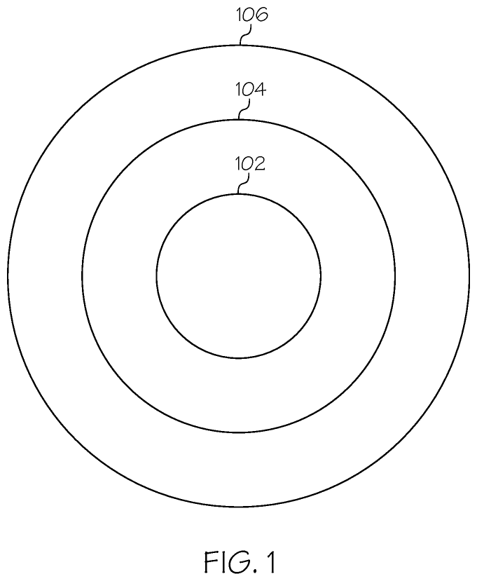

Referring now to FIG. 1, a diagram illustrating the zone of proximal learning is provided. A can-do circle 102 is the innermost circle. The person can handle tasks within the can-do circle 102 without any additional training, instruction or assistance. For example, tasks within the can-do circle 102 may include turning a vehicle on and putting the vehicle into gear. No additional instruction is required for the person. The middle circle is the assistance circle 104, which includes tasks that the person cannot do comfortably on his or her own but can complete with appropriate training, instruction and/or assistance. An example driving task may include passing a vehicle on a fast moving highway. The outermost circle is the cannot-do circle 106, which includes tasks that person cannot complete, even with training, instruction and/or assistance. An example driving tasks may be merging onto a busy highway with a short entrance ramp. The ZPL systems and methods of the present disclosure monitor a driver so that he or she is within a ZPD state within the assistance circle 104. The concept is to push the driver so that he or she is slightly out of his or her comfort zone to improve learning and become more confident when driving.

The diagram illustrated by FIG. 1 is dynamic for each driver and changes over time. It should be appreciated that for a novice driver just starting to drive, the can-do circle 102 and the assistance circle 104 may be much smaller than the cannot-do circle 106. Conversely, the can-do circle 102 and the assistance circle 104 may be much larger than the cannot-do circle 106 for expert drivers. As described in more detail below, the zone of proximal learning systems and methods described herein can be used in a variety of driving applications, such as, without limitation, new driver training (i.e., “driver's education”), driving simulation, racing training, off-road training, and driving coach training.

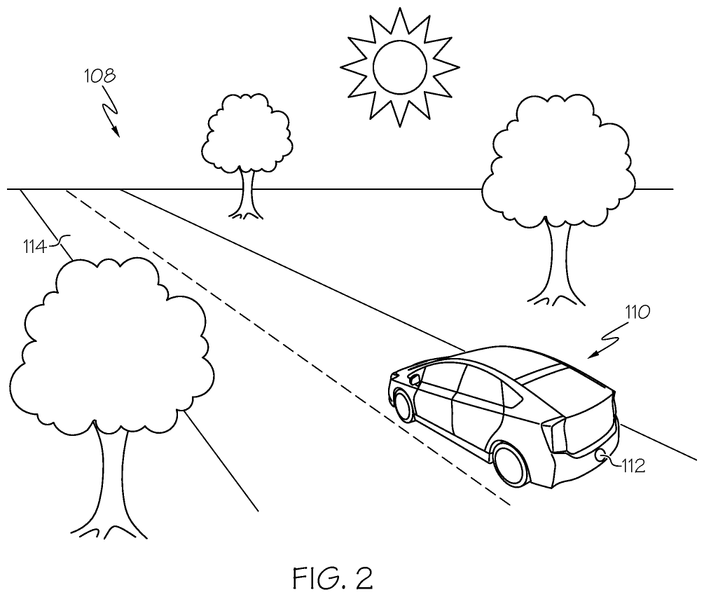

Embodiments are not limited by any ZPD state within the assistance circle 104. The ZPD states will be different for each driver, and will change over time as the driver masters various driving skills. As described in more detail below, a ZPD estimator 152 (FIG. 2) uses a machine learning algorithm to predict which driving tasks a driver has mastered, which driving tasks the driver can perform with assistance, and which driving tasks the driver is not ready for, even with assistance.

In some embodiments, there may be multiple ZPD state categories assigned to a driver, with each ZPD state category having one or more driving tasks associated therewith. Each ZPD state category may relate to a specific aspect of driving. For example, a ZPD state category may be highway passing, and include driving aspects such as use of turn signal, acceleration, vehicle gap awareness and control, amount of traffic, speed, and the like. Another ZPD state category may be parallel parking, which may include driving aspects such as parking space size estimation, approach distance, approach angle, turning, approaching traffic, and the like. It should be understood that any number and type of ZPD state categories may be utilized. A driver may master some ZPD state category before others, for example.

Referring now to FIG. 2, an example vehicle 110 navigating a road 114 within an environment 108 is illustrated. The vehicle 110 includes one or more sensors 112, such as cameras, radar sensors, proximity sensors, lidar sensors, global position system sensors, and the like. Any number of sensors may be provided. The one or more sensors may also include a speedometer, an inertial measurement unit sensor, fuel gauge, and any other vehicle sensor that generate vehicle data relating to vehicle operational parameters. The one or more sensors may also monitor the behavior and characteristics of the driver, such as a driver facing camera to measure facial expressions and biometric sensors, such as a heart monitor, for example. Additional data may be obtained from external sources, such as weather data, traffic data, construction data, and historical accident data.

As described in more detail below, the data collected from various sources is used by the system to generate a driver profile that is then used to estimate the ZPD state or states of the driver.

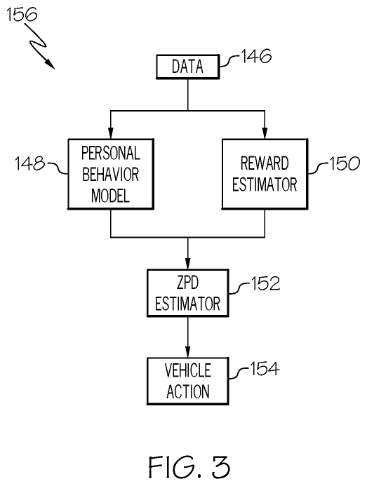

Referring now to FIG. 3, an example ZPL system 156 is schematically illustrated. Generally, the ZPL system 156 includes a personal behavior model 148, a reward estimator 150, and a ZPD estimator 152.

The personal behavior model 148 may predict a driver's performance based on the driver's individual data 146 (such as the driver's past driving experience and driving performance as indicated by the sensor data generated by the one or more sensors 112) and driving learner at large (such as the driving learners with similar driving experience, age, gender, nationality, other relevant attributes). The personal behavior model 148 may further assess the driver's readiness to try new or unfamiliar driving tasks. The personal behavior model 148 may assess the degree of willingness to try new tasks that are different from the learned skills and how closely related these new skills are to the existing ones. The personal behavior model 148 may also predict how proximal the new skills or tasks are to the skills the driver has already learned and whether the driver may be willing to take on the new tasks that are similar to their existing skills or whether the driver may be willing to venture into tasks that are further from the driver's comfort zone.

The personal behavior model 148 may include a machine learning algorithm, and may be a supervised or unsupervised model. Embodiments are not limited by any type of machine learning algorithm that may be used for the personal behavior model 148. Non-limiting examples include classification algorithms, regression algorithms, and clustering algorithms. The personal behavior model 148 utilizes one or more machine learning algorithms to predict or understand the behavior of the driver.

The reward estimator 150 may estimate and/or generate rewards for a specific driver based on the driver's performance, complexity of the driving task, and ZPD states associated with the driver. For example, the reward estimator 150 may provide a top reward for the driver completing a high-level driving task that reflects the driver's ZPD state. The reward estimator 150 may award the driver a basic reward for completing an entry-level driving task that is below the driver's ZPD state. The reward estimator 150 may not reward the driver not completing a driving task reflecting the driver's ZPD state, for example. In some embodiments a reward estimator 150 is not provided.

The operation of the ZPL system 156 may monitor a driver during the training process through various sensors 112. The system may collect driving data of the driver, such as the driver's past driving experience and current driving performance. The ZPL system 156 may then generate a driver profile associated with the driver and analyze the driver profile using the personal behavior model 148. The ZPL system 156 may estimate the ZPD states of the driver using a ZPD estimator 152 that receives outputs from the personal behavior model 148 and/or the reward estimator 150 as inputs. The ZPL system 156 may determine that the generated ZPD states are acceptable when the ZPD states represent the driver's current level of knowledge, skills, or past performance of relevant driving tasks to tackle for assigning next learning tasks. By combining the personal behavior model 148 and reward estimator 150, the ZPL system 156 may tailor its guidance and support to optimize the driver's progress within their ZPL.

In response to the determination that the generated ZPD states are acceptable, the system may then perform one or more vehicle actions 154 to place the driver into the ZPD states such that the system helps the driver operate the vehicle in a way that aligns with the driver's current level of competence and learning needs. The vehicle actions 154 may include instructions for the driver to perform certain driving tasks associated with a ZPD. These instructions may be audio instructions over the sound system of the vehicle and/or visual instructions on a vehicle display. As another example, the vehicle actions 154 may include transmitting instructions to a driving instructor that is teaching the driver how to drive. For example, the instructions may be transmitted to a computing device operated by the driving instructor. The driving instructor may then verbally relay the instructions to the driver. Embodiments are not limited by any particular instructions. As non-limiting examples, the instructions may be “Please speed up to the speed limit,” “Please turn left and then drive through the round-a-bout,” and “Exit the highway at the next exit.” The instructions may also include recommendations and suggestions to the driver, such as, without limitation, “Slow down when going into the upcoming curve,” “Keep checking your rearview mirror,” and “Remember to stop at the correct location at the stop sign.”

The vehicle actions 154 may also be autonomous control of the vehicle 110 such that the vehicle is autonomously moved into a state appropriate for the particular ZPD. For example, the vehicle may notify the driver that it is taking control and will navigate to a situation that is within a particular ZPD state. As a non-limiting example, the vehicle may autonomously enter a highway on an entrance ramp and position itself into a flow of traffic that matches the desired ZPD state. The vehicle 110 may then notify the driver that he or she needs to take over control of the vehicle 110. As another example, the vehicle 110 actions may autonomously perform some maneuvers in an assisted control mode while the driver is operating the vehicle, such as slightly accelerating, slighting turning, slightly braking, and the like. During these assisted maneuvers the vehicle 110 may provide messages to the driver that the vehicle 110 is performing the controls.

The ZPL system 156 may continue collecting the driving performance data of the driver and further update the driver behavior profile and the ZPD states of the driver through the training process.

In embodiments, the ZPL system 156 may start with generating basic tasks at the lower end of the ZPD. The ZPL system 156 may provide tasks to the driver to perform basic tasks like starting the engine, steering, pressing the pedals, or other tasks related to beginner skills. The ZPL system 156 then collects the performance of the driver to generate an initial driver profile and based on the initial profile to characterize and estimate the level of the driving skills of the driver. For each achieved assigned task, the ZPL system 156 may credit the driver with rewards, such as points required to be accumulated to satisfy a driving course.

The ZPL system 156 may generate the ZPD state to reflect the driving skills and level of the driver. The ZPD state may include driving tasks involving skills that the driver may already master but not proficient, or/and tasks involving new skills that the driver may acquire with the help of the system, e.g. by reminding the driver to perform certain activities during the driving session. Accordingly, the ZPL system 156 may help the driver to be more proficient in the learned driving skills and learn new skills at a steady pace.

The ZPD estimator 152 may include a machine-learning algorithm to estimate the level of ZPD state by leveraging the outputs of the personal behavior model 148 and the reward estimator 150. The machine-learning algorithm may be trained to provide desirable difficult level of tasks for the driver to learn the driving.

The sensors 112 of the ZPL system 156 may collect data such as steering, vehicle trace, driver's performance to determine if an assigned driving task is fulfilled by the driver. In embodiments, the ZPL system 156 may include a machine-learning algorithm to determine the performance of the driver and the reasonableness of the assigned ZPD states. The machine learning algorithm may be trained based on a dataset containing a wide range of driving performance related to different driving tasks and ZPD states associated with the driving tasks by different drivers. The training effectiveness of the machine learning algorithm is validated using multiple evaluation metrics, such as driver's feedback and performance improvement trends.

The ZPL system 156 is configured to continuously push the driver into more advanced ZPD states as he or she masters various driving tasks. By continuously placing the driver into situations corresponding with the assistance circle 104 of FIG. 1, the driver is continuously just out of his or her comfort zone and can gain more advanced driving skills with assistance and training. As stated above, the assistance and training may be provided by automatic audio and or visual messaged provided to the driver, such as “Now apply the accelerator and pass the vehicle on the left.” In other embodiments, the vehicle 110 may autonomously perform some functions as needed to assist the driver successfully perform within a ZPD (e.g., provide additional acceleration or braking as needed).

The ZPL system 156 may be utilized in a variety of applications. As stated above, the ZPL system 156 may be used in a driver's education program that trains new drivers. The ZPL system may also be used to train truck drivers, such as in a commercial driver's license (CLC) training program. As another example, the ZPL system 156 may be used to train drivers in overland and/or off-roading. Off-roading trails are typically rated on a scale of 1 to 10. The ZPL system can be used to encourage drivers to operate in ZPD states associated with off-roading trails that suit their skill level, and assist them in mastering maneuvers such that they can drive on 10-rated off-road trails without assistance. The ZPL system 156 can also be used in driver simulation programs, where the behavior and the skill level of the driver is predicted, and the driver simulation program puts the driver into scenarios within the assistance circle 104 to encourage the driver to be slightly out of his or her comfort zone.

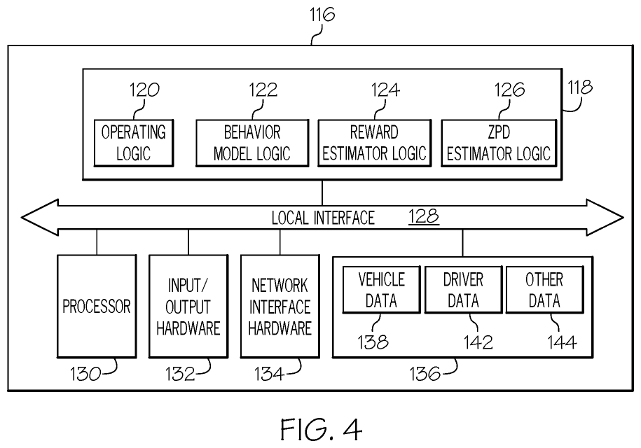

Embodiments of the present disclosure may be implemented by a computing device, and may be embodied as computer-readable instructions stored on a non-transitory memory device. Referring now to FIG. 4, an example system for driver training as a computing device 116 is schematically illustrated. The example computing device 116 provides a system for driver training, and/or a non-transitory computer usable medium having computer readable program code for driver training embodied as hardware, software, and/or firmware, according to embodiments shown and described herein. While in some embodiments, the computing device 116 may be configured as a general purpose computer with the requisite hardware, software, and/or firmware, in some embodiments, the computing device 116 may be configured as a special purpose computer designed specifically for performing the functionality described herein. It should be understood that the software, hardware, and/or firmware components depicted in FIG. 4 may also be provided in other computing devices external to the computing device 116 (e.g., data storage devices, remote server computing devices, and the like).

As also illustrated in FIG. 4, the computing device 116 (or other additional computing devices) may include a processor 130, input/output hardware 132, network interface hardware 134, a data storage component 136 (which may include vehicle data 138 (e.g., data from one or more vehicle sensors), driver data 142 (e.g., data relating to a driver profile, data from one or more driver monitoring sensors, and the like), and any other data 144 for performing the functionalities described herein), and a non-transitory memory component 118. Thus, the data storage component 136 may store historical driver performance data, driver profiles, and historical ZPD states of the driver. The driver performance data may include the collected data regarding one or more actions performed by the driver during the training process. The driver profile may include a driver's past driving experience and driving performance during the training. A ZPD state may include a level of driving skill associated with the driver and training tasks associated with the ZPD state.

The memory component 118 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 118 may be configured to store operating logic 120, personal behavior model logic 122 for predicting a driver's performance and generating a driver profile, reward estimator logic 124 for generating rewards based on driver performance, and ZPD estimator logic for generating driver ZPDs based on outputs from the behavior model logic 122 and the reward estimator logic 124, as described herein (each of which may be embodied as computer readable program code, firmware, or hardware, as an example). It should be understood that the data storage component 136 may reside local to and/or remote from the computing device 116, and may be configured to store one or more pieces of data for access by the computing device 116 and/or other components. The logic components described herein may include one or more machine learning algorithms or neural networks. The one or more modules may be trained and provide machine learning capabilities via a neural network. By way of example, and not as a limitation, the neural network may utilize one or more artificial neural networks (ANNs), one or more convolutional neural networks (CNN), or one or more general adversarial networks (GAN).

A local interface 128 is also included in FIG. 4 and may be implemented as a bus or other interface to facilitate communication among the components of the computing device 116.

The processor 130 may include any processing component configured to receive and execute computer readable code instructions (such as from the data storage component 136 and/or memory component 118). Any number of processors 130 may be utilized. The input/output hardware 132 may include virtual reality headset, graphics display device, keyboard, mouse, printer, sensors, camera, microphone, speaker, touch-screen, and/or other device for receiving, sending, and/or presenting data. The network interface hardware 134 may include any wired or wireless networking hardware, such as a modem, LAN port, wireless fidelity (Wi-Fi) card, WiMax card, mobile communications hardware, and/or other hardware for communicating with other networks and/or devices.

The components illustrated in FIG. 4 are merely exemplary and are not intended to limit the scope of this disclosure. More specifically, while the components in FIG. 4 are illustrated as residing within the computing device 116, this is a non-limiting example. In some embodiments, one or more of the components may reside external to the computing device 116.

It should now be understood that embodiments of the present disclosure are directed to ZPL systems and methods for driver training using ZPD. The systems and methods described herein push a trainee driver to be within one or more ZPD states so that they are operating within states that they can perform with some assistance. In this way, the trainee driver can be slightly out of his or her comfort zone to improve learning and performance. Vehicle actions such as verbal or visual messages can be presented to the driver, as well as autonomous controls of the vehicle, so that the driver is maintained within ZPD states. The ZPL systems and methods described herein can be used in a variety of applications, such as new driver training, CDL training, driving simulation, off-road/overland training, and race car driving training.

As used herein, the singular forms “a,” “an” and “the” include plural referents unless the context clearly dictates otherwise. Thus, for example, reference to “a” component includes aspects having two or more such components unless the context clearly indicates otherwise.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A computer-implemented method for driver training using zone of proximal learning (ZPL), the method comprising:
receiving, by one or more processors, driving data with respect to a driver operating a vehicle;
estimating, using a personal behavior model, a driver profile based on the driving data;
estimating one or more zone of proximal development (ZPD) states based at least in part on the driver profile; and
performing one or more vehicle actions to place the driver into the one or more ZPD states.

2. The computer-implemented method of claim 1, further comprising generating, using a rewards estimator, rewards to the driver based on the driving data, wherein the one or more ZPD states are estimated based on the driver profile and the rewards.

3. The computer-implemented method of claim 1, wherein the rewards estimator is operable to generate one or more rewards when the driving data is indicative of satisfying one or more ZPD states.

4. The computer-implemented method of claim 3, wherein the one or more vehicle actions comprises issuing an instruction to the driver.

5. The computer-implemented method of claim 1, wherein the one or more vehicle actions comprises one or more autonomous vehicle controls.

6. The computer-implemented method of claim 1, further comprising continuously updating the ZPD states over time.

7. A system for driver training using zone of proximal learning (ZPL), the system comprising:
one or more processors;
a non-transitory, computer-readable medium storing instructions that, when executed by the one or more processors, cause the one or more processors to:
receive driving data with respect to a driver operating a vehicle;
estimate, using a personal behavior model, a driver profile based on the driving data;
estimate one or more zone of proximal development (ZPD) states based at least in part on the driver profile; and
generate commands to perform one or more vehicle actions to place the driver into the one or more ZPD states.

8. The system of claim 7, wherein:
the instructions further cause the one or more processors to generate, using a rewards estimator, rewards to the driver based on the driving data; and
the one or more ZPD states are estimated based on the driver profile and the rewards.

9. The system of claim 8, wherein the rewards estimator is operable to generate one or more rewards when the driving data is indicative of satisfying one or more ZPD states.

10. The system of claim 7, wherein the one or more vehicle actions comprises issuing an instruction to the driver.

11. The system of claim 7, wherein the one or more vehicle actions comprises one or more autonomous vehicle controls.

12. The system of claim 7, wherein the ZPD states are continuously updated over time.

13. A vehicle comprising:
one or more sensors operable to generate driving data with respect to a driver operating the vehicle;
one or more processors;
a non-transitory, computer-readable medium storing instructions that, when executed by the one or more processors, cause the one or more processors to:
receive the driving data;
estimate, using a personal behavior model, a driver profile based on the driving data;
estimate one or more zone of proximal development (ZPD) states based at least in part on the driver profile; and
generate commands to perform one or more vehicle actions to place the driver into the one or more ZPD states.

14. The vehicle of claim 13, wherein:
the instructions further cause the one or more processors to generate, using a rewards estimator, rewards to the driver based on the driving data; and
the one or more ZPD states are estimated based on the driver profile and the rewards.

15. The vehicle of claim 14, wherein the rewards estimator is operable to generate one or more rewards when the driving data is indicative of satisfying one or more ZPD states.

16. The vehicle of claim 13, wherein the one or more vehicle actions comprises issuing an instruction to the driver.

17. The vehicle of claim 13, wherein the one or more vehicle actions comprises one or more autonomous vehicle controls.

18. The vehicle of claim 13, wherein the ZPD states are continuously updated over time.

19. The vehicle of claim 13, wherein the driving data comprises one or more of vehicle data, environment data, and driver behavior data.

20. The vehicle of claim 13, wherein the one or more sensors comprises a camera.
